(19) United States
(12) Patent Application Publication
(10) Pub. No.: US 2014/0033584 A1
(43) Pub. Date: Feb. 6, 2014

(54) DEVICE FOR ATTACHING AN ACCESSORY TO A LICENCE PLATE

(71) Applicant: Gray Warren Falkner, Newport (AU)

(72) Inventor: Gray Warren Falkner, Newport (AU)

(21) Appl. No.: 14/005,466

(22) PCT Filed: Mar. 14, 2012
(86) PCT No.: PCT/AU12/00258

§ 371 Date: Oct. 11, 2013

(30) Foreign Application Priority Data
Mar. 15, 2011 (AU) 2011900921

(51) Int. Cl. B60R 13/10

(52) U.S. Cl. CPC B60R 13/105
USPC 40/200

(57) ABSTRACT

A device for attaching an accessory to a licence plate, includes a licence plate attachment portion adapted for attachment to the licence plate; and an accessory attachment portion adapted for attachment to the accessory.

### FIELD OF THE INVENTION

The present invention relates to car accessories and in particular to a device for attaching an accessory to a licence plate.

The invention has been developed primarily for use in conjunction with conventional licence plates and will be described hereinafter with reference to this application. However, it will be appreciated that the invention is not limited to this particular field of use.

### BACKGROUND OF THE INVENTION

Motorists often desire, or are required by law, to display or attach licence plate accessories to their vehicles. For example, legally mandated accessories include accessories indicating the type of driver's licence of the motorist, such as a L-plate indicating that the motorist has a learner's licence or a P-plate indicating that the motorist has a provisional licence. Alternatively, a motorist or car dealers may desire to display vanity accessories, comprising slogans, images and the like.

However, in order to display the licence plate accessory, motorist usually resort to jamming the accessory partially behind the licence plate or using expensive magnetic accessories for magnetic attachment of the accessory to the body of the car.

As such, a need therefore exists for a device for attaching an accessory to a licence plate which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY

An object of the claimed invention is to provide a device for attaching an accessory to a licence plate which will overcome or substantially ameliorate at least some of the deficiencies of the prior art, or to at least provide an alternative.

According to one aspect, there is provided a device for attaching an accessory to a licence plate, the device comprising:
a licence plate attachment portion adapted for attachment to the licence plate; and
an accessory attachment portion adapted for attachment to the accessory.

Advantageously, the device advantageously secures the attachment to the licence plate thereby preventing the accessory from becoming detached whilst in transit. In this manner, the device advantageously addresses the disadvantages of existing arrangements, where motorists usually resort to jamming the accessory partially behind the licence plate or have to buy expensive magnetic accessories for magnetic attachment to the body of the car.

Preferably, the licence plate attachment portion comprises a licence plate clip adapted for attachment to an edge of the licence plate.

Advantageously, the licence plate clip allows for the device to be attached and removed from the licence plate in a simple manner. Furthermore, the licence plate clip provides a simple and robust mechanical arrangement for attachment to the licence plate.

Preferably, the licence plate clip comprises complimentary licence plate clip members defining a licence plate recess for receiving and securing the edge of the licence plate therein. Preferably, at least one of the licence plate clip members is shaped to define a surface adapted to bear upon a contour of the licence plate edge. Preferably, the surface comprises a raised portion. Preferably, the surface is inwardly dished.

Advantageously, the surface may be defined by a raised portion such that the surface is an inwardly facing surface and adapted to bear inwardly against an outwardly facing surface of the edge of the licence plate. Such an arrangement advantageously aids of the securement of the licence plate within the licence plate recess.

Preferably, one of the licence plate clip members reaches beyond the other licence plate clip member.

Advantageously, a relatively shorter licence plate clip member advantageously minimally obscures the surface of the licence plate. Furthermore, a relatively longer licence plate clip member arrangement advantageously stabilises the accessory against torsional forces exerted upon the accessory.

Preferably, the complimentary licence plate clip members comprise a first clip member and a second clip member, wherein the first clip member comprises an inwardly dished portion and extends beyond the second clip member and wherein the second clip member comprises an inwardly orientated lip portion.

Advantageously, the inwardly dished portion advantageously aid in the securement of the edge of the licence plate within the licence plate recess of the licence plate attachment portion.

Preferably, the licence plate recess comprises a first licence plate recess, an intermediate licence plate recess and a second licence plate recess, the intermediate licence plate recess connecting the first licence plate recess to the second licence plate recess, wherein the first licence plate recess is orientated according to a first plane and the second licence plate recess is orientated according to a second plane parallel to and offset from the first plane.

Advantageously, the device may be adapted for securement to licence plates having different edge arrangements, such as licence plates having straight edges, or licence plates having a single contour at the edge of the plate.

Preferably, the accessory attachment portion comprises an accessory clip adapted for attachment to an edge of the accessory.

Advantageously, the accessory clip allows for the device to be attached and removed from the accessory in a simple manner. Furthermore, the accessory provides a simple and robust mechanical arrangement for attachment to the accessory.

Preferably, the accessory clip comprises complimentary accessory clip members defining an accessory recess for receiving and securing the edge of the accessory therein. Preferably, at least one of the accessory clip members is shaped to define a surface adapted to bear upon a contour of the edge of the accessory. Preferably, the surface comprises a raised portion. Preferably, the surface is inwardly dished.

Advantageously, the surface may be defined by a raised portion such that the surface is an inwardly facing surface and adapted to bear inwardly against an outwardly facing surface of the edge of the accessory. Such an arrangement advantageously aids of the securement of the accessory within the accessory recess.

Preferably, one of the accessory clip members reaches beyond the other accessory clip member.

Advantageously, a relatively shorter accessory clip member advantageously minimally obscures the surface of the accessory. Furthermore, a relatively longer accessory clip member arrangement advantageously stabilises the accessory against torsional forces exerted upon the accessory.

Preferably, the complimentary accessory clip members comprise a first clip member and a second clip member, wherein the first clip member comprises an inwardly dished portion and wherein the second clip member comprises a lip portion and extends beyond the second clip member.

Advantageously, the inwardly dished portion advantageously aids in the securement of the edge of the accessory within the accessory recess of the accessory attachment portion.

Preferably, the licence plate attachment portion is shorter than the accessory attachment portion.

Advantageously, as the licence plate is typically more secure and robust than the accessory, the licence plate attachment portion need not be as long as the accessory attachment portion, thereby saving in material.

Preferably, the device further comprises a flexible coupling between the licence plate attachment portion and the accessory attachment portion.

Advantageously, such a flexible coupling allows the accessory to move relative to the licence plate to absorb torsional forces exerted upon the accessory or to assist a motorist in attaching the accessory to the accessory attachment portion.

Preferably, the flexible coupling is a live hinge.

Advantageously, such a live hinge advantageously allows for the device to be extruded during production, thereby saving in assembly costs.

Preferably, the flexible coupling is substantially elastic.

Advantageously, the accessory attachment portion is biased towards a neutral orientation in relation to the licence plate attachment portion.

Preferably, the flexible coupling is substantially coplanar with an upper or lower surface of the device.

Advantageously, such an arrangement advantageously allows the accessory attachment portion to move without bearing upon the body of the vehicle in use.

Preferably, the flexible coupling is an articulated coupling.

Advantageously, such an articulated coupling provides a more durable flexible coupling as compared to a live hinge.

Preferably, the articulated coupling comprises complimentary female and male couplings. Preferably, the female and male couplings are rotatably coupled.

Advantageously, the licence plate attachment portion may be orientated with respect to the accessory plate attachment portion

Preferably, the male coupling comprises a cylindrical member and the female coupling comprises an elongate recess adapted for complimentary receiving the cylindrical member lengthwise therein.

Advantageously, the licence plate receiving portion and the accessory receiving portion may be manufactured separately, and during assembly the licence plate receiving portion and the accessory receiving portion may be forced together to allow the interlock of the cylindrical member within the female coupling.

Preferably, the articulated coupling is adapted to allow the licence plate attachment portion to be orientated substantially up to 90 degrees with respect to the accessory attachment portion. Preferably, the male coupling further comprises an anchor member fixed at a centre portion of the cylindrical member. Preferably, the elongate recess comprises a first portion having a first elongate recess and a second elongate recess adapted for receiving respective distal portions about the centre portion of the cylindrical member therein.

Advantageously, the articulated coupling is adapted to allow the licence plate attachment portion to be orientated substantially up to 90 degrees with respect to the accessory attachment portion.

Preferably, the flexible coupling is a bi-articulated coupling.

Advantageously, such a bi-articulated coupling allows the accessory to be offset from the plane of the licence plate.

Preferably, the bi-articulated coupling comprises a mid portion having a first end having a female coupling and a second end, distal to the first end, having a male coupling.

Advantageously, the mid portion may advantageously be used as an optional accessory wherein the licence plate attachment portion may be coupled directly to the accessory attachment portion or wherein the licence plate attachment portion may be coupled to the accessory attachment portion using the mid portion.

Preferably, the mid portion further comprises a hollow portion. Advantageously, the hollow portion saves on material.

Preferably, the accessory attachment portion comprises an accessory engagement for releasably engaging a portion of the accessory.

Advantageously, different types of accessories may be attached to the licence plate.

Preferably, the accessory engagement is adapted to engage the accessory substantially at orientational increments of 90 degrees. Preferably, the accessory engagement is rectangular in cross section. Preferably, the accessory attachment portion comprises a plate and the accessory engagement is a cut-out in the plate.

Advantageously, the accessory engagement may advantageously be adapted to engage the accessory substantially at orientational increments of 90 degrees to as to allow for the correct orientation of the information presented by the accessory.

Preferably, the device further comprises the accessory. Preferably, the accessory comprises arrowhead releasable attachment bosses for engaging the accessory engagement.

Advantageously, the arrowhead releasable attachment bosses securely fasten the accessory to the accessory engagement.

Preferably, the accessory is substantially circular. Preferably, the accessory comprises a recessed area adapted for receiving a media disk therein.

Advantageously, the accessory may be adapted for receiving and securing a media disk.

Preferably, the accessory engagement is a female coupling adapted for receiving and securing a male portion of the accessory therein. Preferably, the device further comprises the accessory. Preferably, the male portion is an elongate rib having a cross section comprising a semi-circular portion. Preferably, the female coupling comprises a substantially circular recess adapted for rotatably engaging the male portion therein.

Advantageously, the accessory may rotate with respect to the accessory engagement.

Preferably, the cross section of the rib comprises a stopping portion adjacent to the semi-circular portion and adapted to limit the rotation of the accessory with respect to the accessory engagement.

Advantageously, the stopping portion may be adapted to limit the rotation of the accessory with respect to the accessory engagement.

Preferably, the accessory comprises a substantially rectangular portion. Preferably, the accessory comprises a recessed area adapted for receiving a media banner therein.

Advantageously, the accessory may be suited for receiving and securing a media banner therein.

Other aspects of the invention are also disclosed.

### BRIEF DESCRIPTION OF THE DRAWINGS

Notwithstanding any other forms which may fall within the scope of the present invention, preferred embodiments of the invention will now be described, by way of example only, with reference to the accompanying drawings in which:

FIG. 1 shows a device for attaching an accessory to a licence plate in accordance with an embodiment of the present invention;

FIG. 2 shows a magnified view of the device given in FIG. 1 in accordance with an embodiment of the present invention;

FIGS. 3a and 3b show cross sectional views of further embodiments of the present invention;

FIGS. 4a and 4b shown an articulated coupling in accordance with another embodiment of the present invention;

FIG. 5 shows the female and male couplings of the articulated coupling given in FIG. 4 in accordance with another embodiment of the present invention;

FIG. 6 shows the male coupling of the embodiment given in FIG. 5 having an anchor member fixed at a centre portion of the cylindrical member in accordance with another embodiment of the present invention;

FIG. 7 shows a bi-articulated coupling in accordance with another embodiment of the present invention; and

FIGS. 8 and 9 shows an accessory attachment portion is adapted for attachment to complimentary accessories in accordance with another embodiment of the present invention.

### DETAILED DESCRIPTION OF SPECIFIC EMBODIMENTS

It should be noted in the following description that like or the same reference numerals in different embodiments denote the same or similar features.

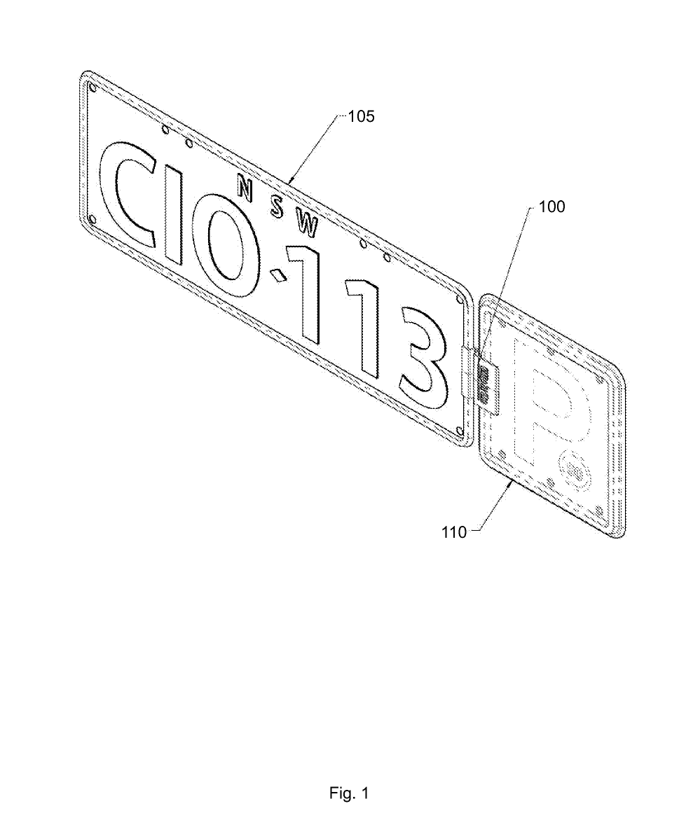

FIG. 1 shows a device 100 for attaching an accessory 110 to a licence plate 105. In the embodiments described herein, the accessory is typically a legally mandated accessory, such as an accessory indicating the type of driver's licence of the motorist, including L-plates, P-plates and the like or vanity accessories, comprising slogans, images and the like.

In one embodiment, the device advantageously secures the attachment 110 to the licence plate 105 thereby preventing the accessory from becoming detached whilst in transit. In this manner, the device advantageously overcomes the disadvantages of existing arrangements, where motorists usually resort to jamming the accessory partially behind the licence plate or have to buy expensive magnetic accessories for magnetic attachment to the body of the car.

In the embodiment given in FIG. 1, the device 100 is shown to attach to a standard Australian licence plate 105 and in particular a licence plate 105 from the state of New South Wales. However, and as described in further detail below, the device may be adapted for attachment to different types of licence plates. Furthermore, while the embodiment shown in FIG. 1 shows the device 100 attached to a New South Wales provisional licence indicator plate accessory 110, the device may be adapted for attachment to other types of licence plate accessories 110, some of which are described herein.

In one embodiment, the device is approximately 41 mm in length, 40 mm in breadth and 7 mm in height. Other dimensions may be used depending on the application.

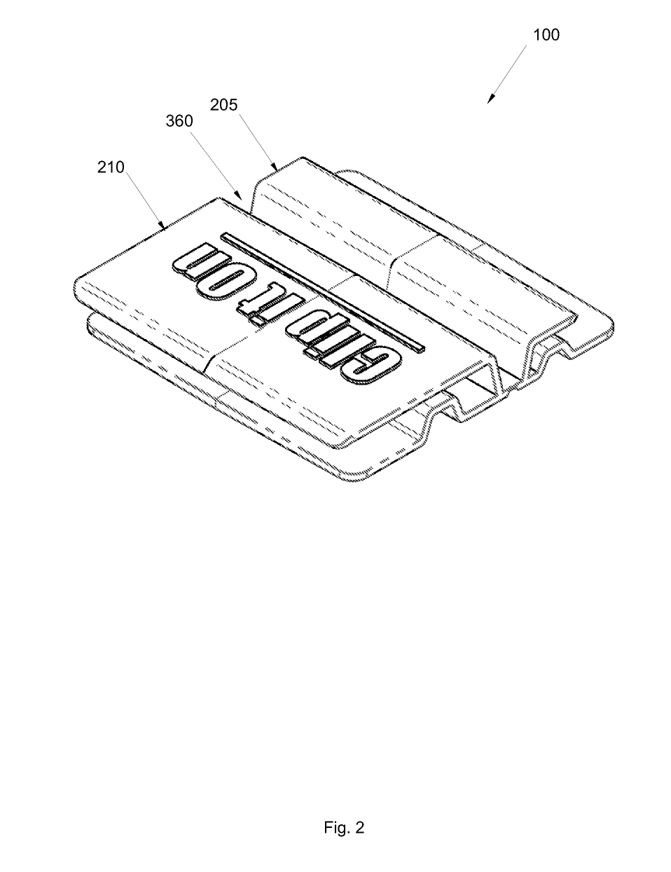

FIG. 2 shows a magnified view of the device 100. The device 100 comprises a licence plate attachment portion 205 adapted for attachment to the licence plate 105 and an accessory attachment portion 210 adapted for attachment to the accessory 110.

It should be noted that in certain embodiments, the device may be provided with only one or either the licence plate attachment portion 205 or the accessory attachment portion 210. For example, the device may be provided with a magnetic or suction type backing and an accessory attachment portion 210. As such, a motorist may secure the accessory 110 to the device 100 using the accessory attachment portion 210 and magnetically or suctionally secure the device 100 to the body of the car.

Whilst the device 100 may be manufactured from any material depending on the application, the device 100 is preferably manufactured from a cost effective, lightweight and durable plastic material such as polypropylene.

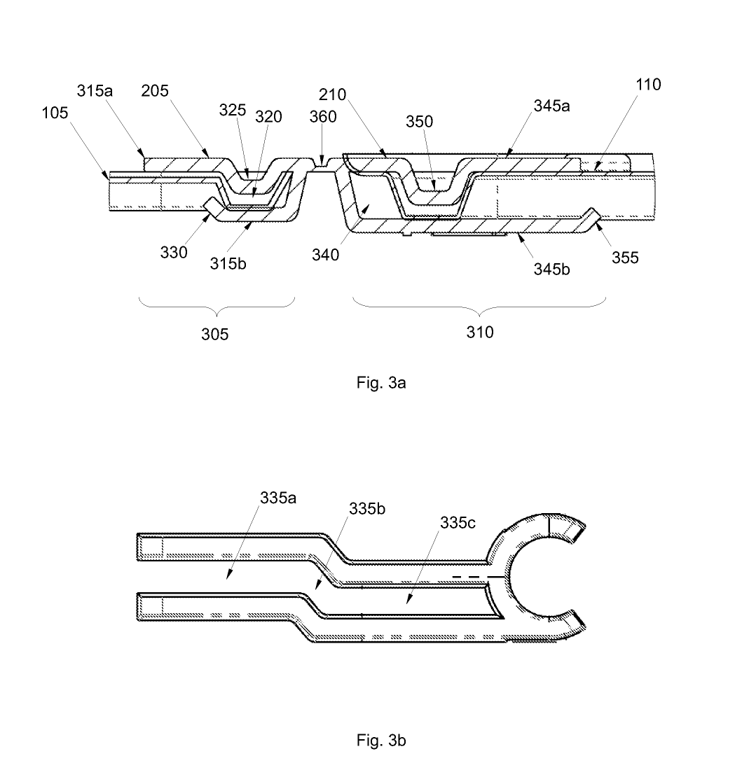

FIGS. 3a and 3b show cross sectional views of two embodiments of the device 100. FIG. 3a shows an embodiment of the device 100 in which the licence plate attachment portion 205 comprises a licence plate clip 305 adapted for attachment to an edge of the licence plate 105. The licence plate clip 305 comprises complimentary licence plate clip members 315 defining a licence plate recess 320 for receiving and securing the edge of the licence plate 105 therein. In the embodiment given in FIG. 3a, the licence plate recess 320 may be about 6 mm wide.

In order to aid the securement of the licence plate 105 within the licence plate recess 320, at least one of the licence plate clip members 315 is shaped to define a surface adapted to bear inwardly upon a contour of the edge of the licence plate 105. For example, the surface may be defined by a raised portion such that the surface is an inwardly facing surface and adapted to bear inwardly against an outwardly facing surface of the edge of the licence plate 105.

Further specifically, in the embodiment given in FIG. 3a, the complimentary licence plate clip members 315 comprise a first clip member 315a and a second clip member 315b. The first clip member 315a comprises an inwardly dished portion 325 and extends beyond the second clip member 315b. As such, the surface adapted to bear inwardly upon a contour of the edge of the licence plate 105 may be defined by the inwardly dished portion 325 of the licence plate clip 305. Such an inwardly dished 325 portion advantageously secures the licence plate 105 within the licence plate recess 320. Yet further, the second clip member may comprise an inwardly orientated lip portion 330. As such, the surface may be defined by the inwardly orientated lip portion 330 of the licence plate clip 305. In alternative embodiments, the surface adapted to bear inwardly upon a contour of the edge of the licence plate 105 may be defined by other configurations, such as inwards extrusions of various shapes.

In the embodiment shown in FIG. 3a, one of the licence plate clip members 315a reaches beyond the other licence plate clip member 315b. The relatively shorter licence plate clip member 315b arrangement advantageously minimally obscures the surface of the licence plate 105. Furthermore, the relatively longer licence plate clip member 315a arrangement advantageously provides leverage between the licence plate 105 and the body of the car to resist against torsional forces exerted upon the accessory.

FIG. 3b shows a further embodiment of the device 100 adapted for securement to licence plates 105 having a different edge arrangement than those for which the embodiment given in FIG. 3a is designed for. Such licence plates 105 typically have straight edges, or a single contour at the edge of the plate. In the embodiment given in FIG. 3b, the licence plate recess 335 may be about 1.5 mm wide.

The embodiment given in FIG. 3b comprises a licence plate recess comprising a first licence plate recess 335a, an intermediate licence plate recess 335b and a second licence plate recess 335c. The intermediate licence plate recess 335b connects the first licence plate recess 335a to the second licence plate recess 335c. The first licence plate recess 335a is orientated according to a first plane and the second licence plate recess is orientated according to a second plane 335c parallel to and offset from the first plane. In this manner, the intermediate recess 335b is adapted to define the surface adapted to bear inwardly upon a contour of the edge of the licence plate 105.

In certain embodiments, the licence plate recess may be a straight recess, wherein the licence plate attachment portion 205 is adapted to attach to planar licence plates 105, such as plastic licence plates. In this manner, the licence plate attachment portion 205 relies on static friction to secure the licence plate 105 within the licence plate attachment portion 205.

Turning now to the accessory attachment portion 210, as shown in FIG. 3a, the accessory attachment portion 210 similarly comprises an accessory clip 310 adapted for attachment to an edge of the accessory 110.

The accessory clip 310 comprises complimentary accessory clip members 345 defining an accessory recess 340 for receiving and securing the edge of the accessory 110 therein. In the embodiment given in FIG. 3a, the accessory recess 340 may be about 7 mm wide.

In a similar manner as in the case of the licence plate attachment portion 305, at least one of the accessory clip members 345 may be shaped to define a surface adapted to bear inwardly upon a contour of the edge of the accessory 110. Such a surface may be defined by a raised portion a raised portion or one or the accessory clip members 345. In the embodiment shown in FIG. 3a, the accessory clip member 345a comprises an inwardly dished portion 350 defining an inwardly facing surface adapted to bear upon an outwardly facing surface of the edge of the accessory 110. In this manner, the inwardly dished portion 350 advantageously aid in the securement of the edge of the accessory 110 within the accessory recess 340 of the accessory attachment portion 310. Furthermore, in the embodiment given in FIG. 3, the accessory clip member 345b comprises an inwardly facing lipped portion 355, further providing an inwardly facing surface adapted to aid in the securement of the edge of the accessory 110 within the accessory recess 340 of the accessory attachment portion 310.

In the embodiment given in FIG. 3, one of the accessory clip members 345 reaches beyond the other accessory clip member 345. Specifically, the complimentary accessory clip members 345 comprise a first clip member 345a and a second clip member 345b, wherein the first clip member 345a comprises an inwardly dished portion 350 and wherein the second clip member 345b comprises the lip portion 355 and extends beyond the first clip member 345a.

In the embodiment given in FIG. 2, the licence plate attachment portion 205 is shorter than the accessory attachment portion 210. Such an arrangement advantageously provides an enlarged surface area on one side of the device 100 for embossing logos and the like thereon. However, in alternative embodiments, the licence plate attachment portion 205 or the accessory attachment portion 210 may be of adjusted according to the application. In the embodiment shown in FIG. 2, the licence plate attachment portion 205 is about 16 mm in length and the accessory attachment portion 210 is about 25.4 mm in length.

While in certain embodiments, the licence plate attachment portion 205 and the accessory attachment portion 210 may be fixed together, in one preferred embodiment, the device 100 further comprises a flexible coupling between the licence plate attachment portion and the accessory attachment portion. Such a flexible coupling advantageously allows the accessory 110 to move relative to the licence plate 105 to absorb torsional forces exerted upon the accessory 110 or to assist a motorist in attaching the accessory 110 to the accessory attachment portion 210.

In the embodiment given in FIG. 3a, the flexible coupling is a live hinge 360. Such a live hinge 360 advantageously allows for the device to be extruded during production, thereby saving in assembly costs. The flexible coupling is manufactured from a suitable material and shaped so as to be substantially elastic such that the accessory attachment portion 205 is biased towards a neutral orientation in relation to the licence plate attachment portion 205.

In the embodiment given in FIG. 3a, the flexible coupling is substantially coplanar with a lower surface of the device 110. Such an arrangement advantageously allows the accessory attachment portion 205 to move without bearing upon the body of the vehicle in use.

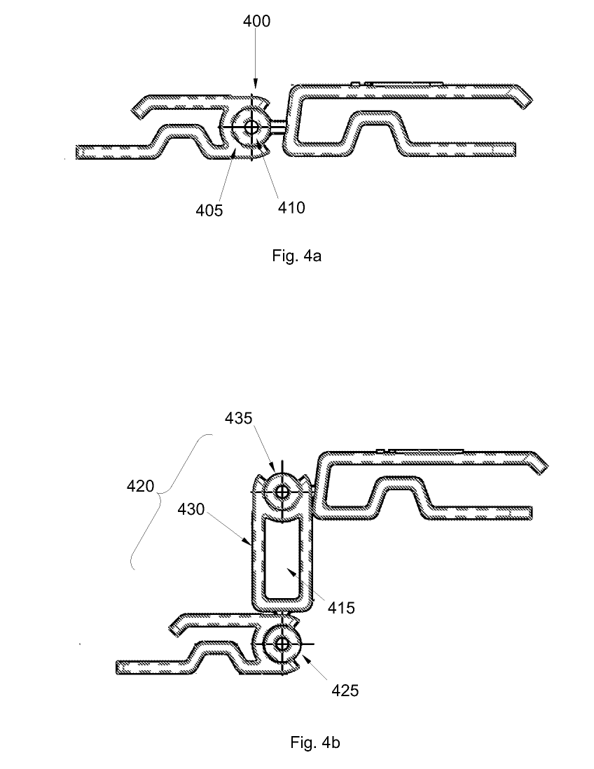

However, while live hinges 360 may be cost effective couplings, live hinges 360 may break from repeated use. As such, in one embodiment, as shown in FIGS. 4a and 4b, the flexible coupling is an articulated coupling 400. Such an articulated coupling provides a more durable flexible coupling as compared to a live hinge 360.

Referring now to the embodiment given in FIG. 4a, the articulated coupling 400 comprises complimentary female 405 and male 410 couplings. In this particular embodiment, the female coupling 405 may have an inner diameter of 3 mm.

As is evident from FIG. 4a, the female 405 and male 410 couplings are rotatably coupled thereby allowing the licence plate attachment portion 205 to be orientated with respect to the accessory plate attachment portion 210.

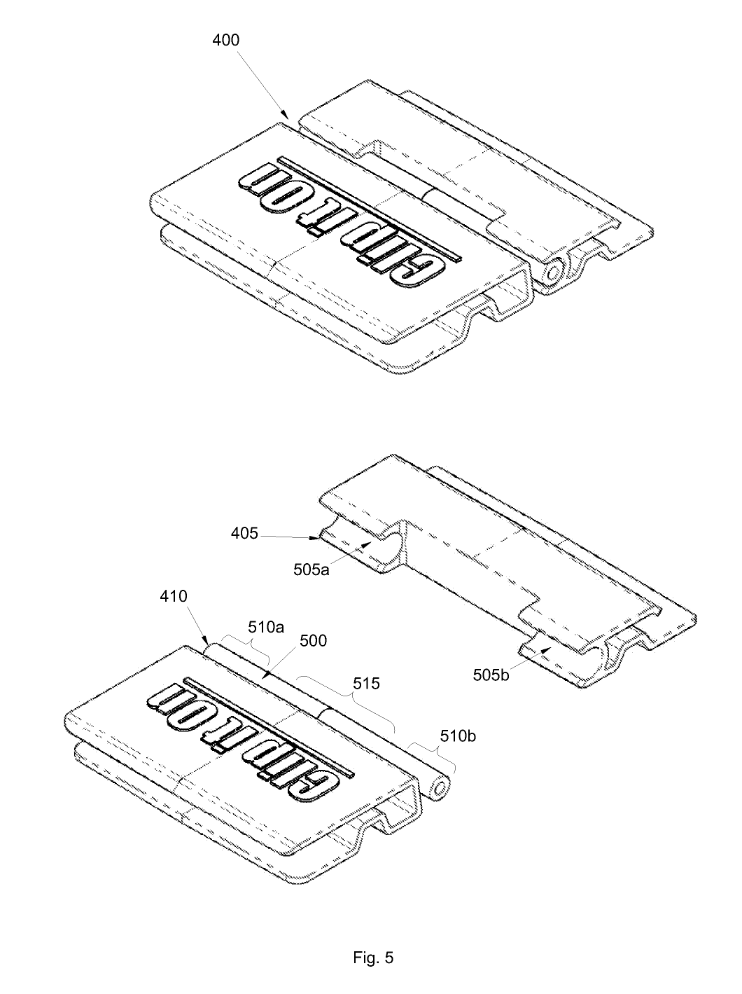

Further representations elaborating on the nature of the female 405 and male 410 couplings are given in FIG. 5. Specifically, the male coupling 410 comprises a cylindrical member 500 and the female coupling 405 comprises an elongate recess 505 adapted for complimentary receiving the cylindrical member 500 lengthwise therein. As such the licence plate receiving portion 205 and the accessory receiving portion 210 may be manufactured separately, and during assembly the licence plate receiving portion 205 and the accessory receiving portion 210 may be forced together to allow the interlock of the cylindrical member 500 within the female coupling 405.

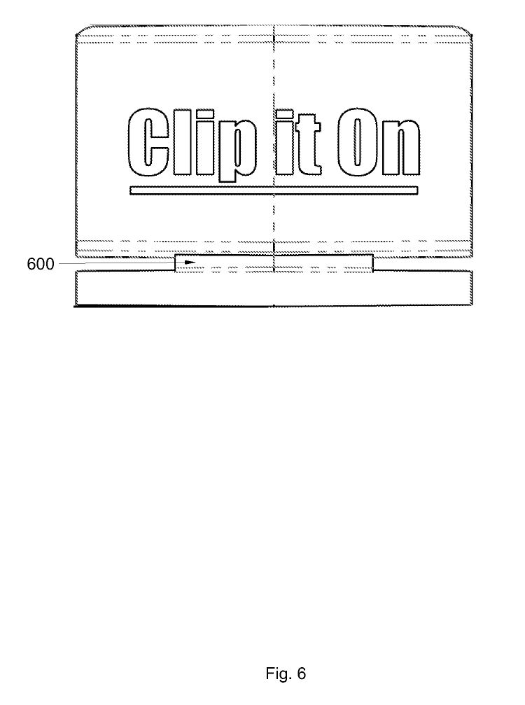

On one embodiment, the articulated coupling 400 is adapted to allow the licence plate attachment portion 205 to be orientated substantially up to 90 degrees with respect to the accessory attachment portion 210. For example, and as further elaborated in FIG. 6, the male coupling 410 further comprises an anchor member 600 fixed at a centre portion 515 of the cylindrical member 500. Furthermore, the elongate recess 505 comprises a first portion having a first elongate recess 505a and a second portion having a second elongate recess elongate recess 505b adapted for receiving respective distal portions 510 about the centre portion 515 of the cylindrical member 500 therein.

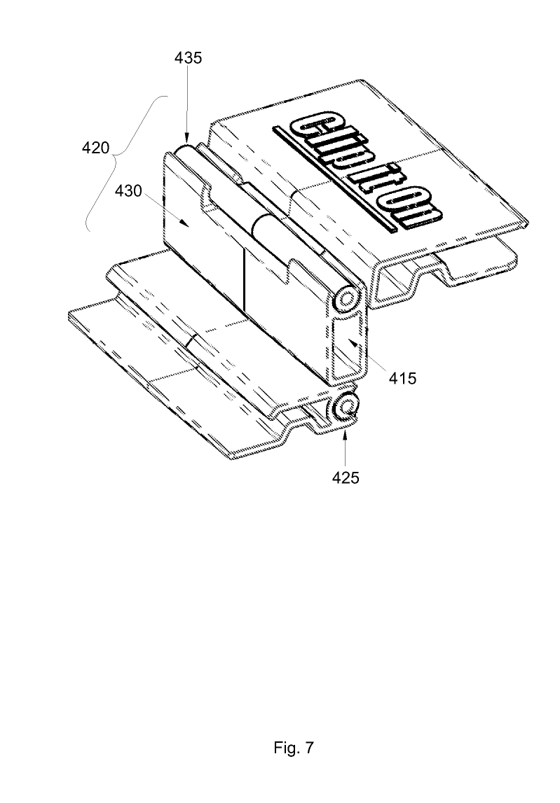

FIGS. 4b and 7 show a further embodiment of the device 100 in which the flexible coupling is a bi-articulated coupling 420. Such a bi-articulated coupling 420 advantageously allows the accessory to be offset from the plane of the licence plate 105. Further specifically, the bi-articulated coupling 420 comprises a mid portion 430 having a first end 435 having a female coupling and a second end 425, distal to the first end, having a male coupling. As such, the mid portion 430 may advantageously be used as an optional accessory wherein the licence plate attachment portion 205 may be coupled directly to the accessory attachment portion 210 or wherein the licence plate attachment portion 205 may be coupled to the accessory attachment portion 210 using the mid portion 430. Furthermore more than one mid portion 430 may be joined, thereby providing a tri-articulated coupling, for example.

The mid portion may further comprise a hollow portion 415, thereby saving on material.

In certain embodiments the device 100 may be adapted for accessories 210 other than those shown in FIG. 1. In these embodiments, the accessories 210 may be adapted for attachment to the accessory attachment portion 210 in the manner described further below.

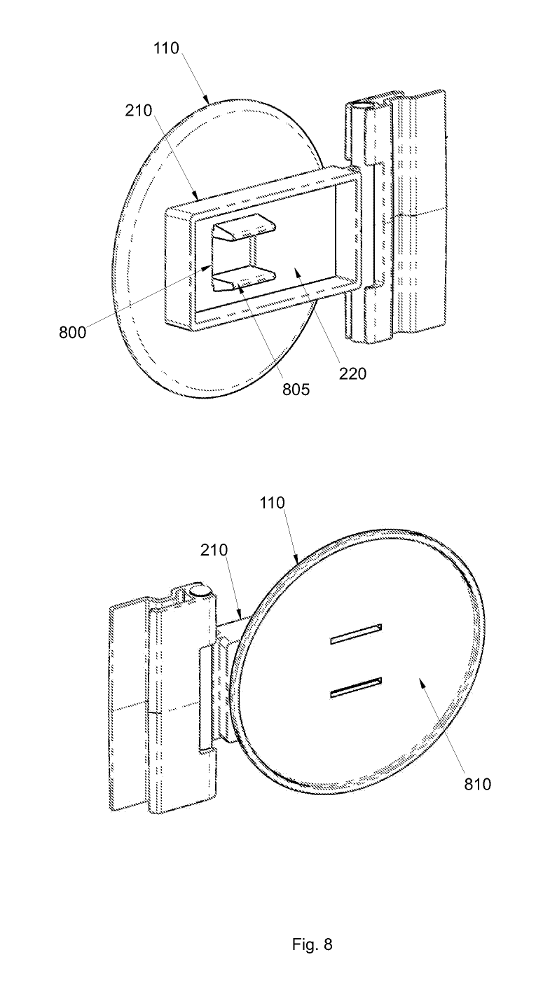

One such embodiment is given in FIG. 8 where the accessory attachment portion 210 is adapted for attachment to complimentary accessory 110. Specifically, in the embodiment given in FIG. 8, the accessory attachment portion 210 comprises an accessory engagement 800 for releasably engaging a portion of the accessory 110.

In the embodiment given in FIG. 8, the accessory 110 is a substantially circular media disk holder having a recessed area 810 adapted for receiving and securing a media disk therein. As such, the accessory engagement 800 may advantageously be adapted to engage the accessory 110 substantially at orientational increments of 90 degrees to as to allow for the correct orientation of the information presented by the media disk. So as to engage the accessory 110 substantially at orientational increments of 90 degrees, the accessory engagement 800 may be rectangular in cross section, and in particular, the accessory attachment portion 210 may comprises a plate 220 wherein the accessory engagement 800 comprises a cut-out in the plate 220.

In one embodiment, the accessory 210 may comprise attachment means 805 for releasable attachment to the accessory engagement 800. In the embodiment given in FIG. 8, the accessory 210 comprises arrowhead releasable attachment bosses 805 for engaging the accessory engagement 800.

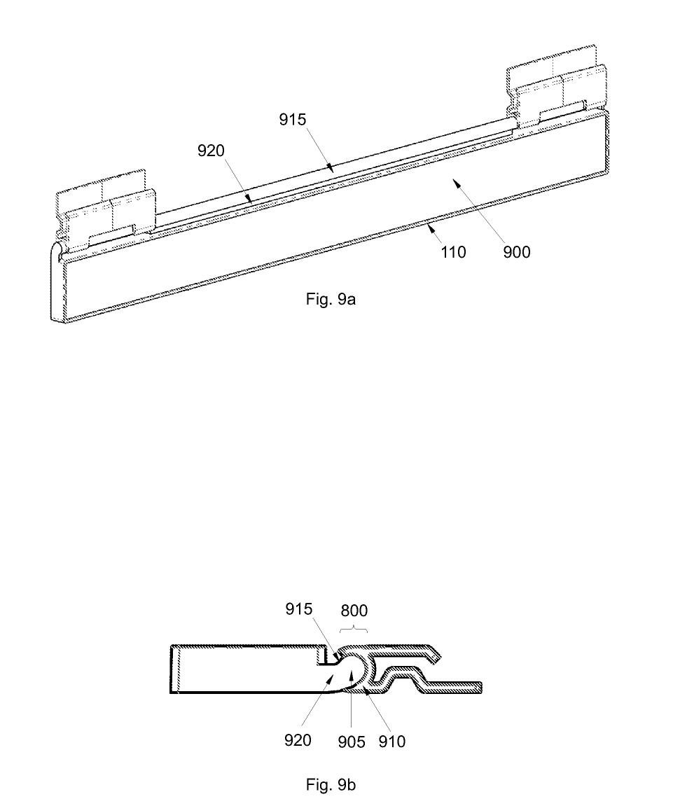

In another embodiment, the accessory 210 may be a media banner for displaying a logo alongside the licence plate, such as an advertisement from a car dealer. Such an embodiment is shown in FIGS. 9a and 9b wherein the accessory 110 is a media banner. The media banner may be substantially rectangular and have a recessed area 900 for receiving a banner therein.

In the embodiment given in FIG. 9b, the accessory engagement 800 comprises a female coupling 910 adapted for receiving and securing a male coupling 905 of the accessory therein, as elaborated in FIG. 9b.

While in some embodiments the accessory engagement 800 may be adapted to fix the accessory 210 in place, in one particular embodiment, the male portion 905 may take the form of an elongate rib 915 having a cross section comprising a semi-circular portion. Furthermore, the female coupling 905 may comprise a substantially circular recess adapted for rotatably engaging the male portion therein, as shown in FIG. 9b. In this manner, the accessory 210 may rotate with respect to the accessory engagement 800. The rib 915 comprises a stopping portion 920 adjacent to the semi-circular portion and adapted to limit the rotation of the accessory 210 with respect to the accessory engagement 800.

### INTERPRETATION

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the car accessory industry.

1-47. (canceled)

48. A device for attaching an accessory to a licence plate, the device comprising;
a licence plate attachment portion adapted for attachment to the licence plate; and
an accessory attachment portion adapted for attachment to the accessory.

49. A device as claimed in claim 48, wherein the licence plate attachment portion comprises a licence plate clip adapted for attachment to an edge of the licence plate.

50. A device as claimed in claim 49, wherein the licence plate clip comprises complimentary licence plate clip members defining a licence plate recess for receiving and securing the edge of the licence plate therein.

51. A device as claimed in claim 50, wherein at least one of the licence plate clip members is shaped to define a surface adapted to bear upon a contour of the licence plate edge.

52. A device as claimed in claim 51, wherein the surface comprises a raised portion.

53. A device as claimed in claim 51, wherein the surface is inwardly dished.

54. A device as claimed in claim 50, wherein one of the licence plate clip members reaches beyond the other licence plate clip member.

55. A device as claimed in claim 50, wherein the complimentary licence plate clip members comprise a first clip member and a second clip member, wherein the first clip member comprises an inwardly dished portion and extends beyond the second clip member and wherein the second clip member comprises an inwardly orientated lip portion.

56. A device as claimed in claim 50, wherein the licence plate recess comprises a first licence plate recess, an intermediate licence plate recess and a second licence plate recess, the intermediate licence plate recess connecting the first licence plate recess to the second licence plate recess, wherein the first licence plate recess is orientated according to a first plane and the second licence plate recess is orientated according to a second plane parallel to and offset from the first plane.

57. A device as claimed in claim 48, wherein the accessory attachment portion comprises an accessory clip adapted for attachment to an edge of the accessory.

58. A device as claimed in claim 57, wherein the accessory clip comprises complimentary accessory clip members defining an accessory recess for receiving and securing the edge of the accessory therein.

59. A device as claimed in claim 58, wherein at least one of the accessory clip members is shaped to define a surface adapted to bear upon a contour of the edge of the accessory.

60. A device as claimed in claim 59, wherein the surface comprises a raised portion.

61. A device as claimed in claim 59, wherein the surface is inwardly dished.

62. A device as claimed in claim 57, wherein one of the accessory clip members reaches beyond the other accessory clip member;

63. A device as claimed in claim 58, wherein the complimentary accessory clip members comprise a first clip member and a second clip member, wherein the first clip member comprises an inwardly dished portion and wherein the second clip member comprises a lip portion and extends beyond the second clip member.

64. A device as claimed in claim 48, further comprising a flexible coupling between the licence plate attachment portion and the accessory attachment portion.

65. A device as claimed in claim 64, wherein the flexible coupling is substantially coplanar with an upper or lower surface of the device.

66. A device as claimed in claim 65, wherein the flexible coupling is an articulated coupling.

67. A device as claimed in claim 66, wherein the articulated coupling comprises complimentary female and male couplings.
